(19) United States
(12) Patent Application Publication
(10) Pub. No.: US 2008/0198443 A1
(43) Pub. Date: Aug. 21, 2008

(54) ELECTROPHORETIC DISPLAY MEDIUM AND METHOD OF MANUFACTURING THE SAME

(76) Inventors: Chisato Yoshimura, Nagoya-shi (JP); Yasuhiro Hattori, Cordova, TN (US)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/037,253

(22) Filed: Feb. 26, 2008

Related U.S. Application Data
(63) Continuation-in-part of application No. PCT/JP2006/316236, filed on Aug. 18, 2006.

(30) Foreign Application Priority Data
Aug. 26, 2005 (JP) 2005246025

(51) Int. Cl. G02F 1/167; B29C 45/00

(52) U.S. Cl. 359/296; 264/328.1; 264/238

(57) ABSTRACT

An electrophoretic display medium includes a first substrate and a second substrate disposed in opposition to each other, a dispersion medium injected between the first substrate and second substrate and having charged particles dispersed therein, and a partition member that partitions a space between the first substrate and the second substrate. A manufacturing method includes a clamping step for clamping the surface of a first die having a partition-forming groove pattern to form the partition member against the first substrate, an injecting step for injecting a resin into spaces formed between the first die and the first substrate, and a molding step for solidifying the resin injected into the spaces.

### CROSS REFERENCE TO RELATED APPLICATION

This application claims priority from Japanese Patent Application No 2005-246025 filed Aug. 26, 2005. This application is also a continuation-in-part of International Application No. PCT/JP2006/316236 filed Aug. 18, 2006 in Japan Patent Office as a Receiving Office. The contents of both applications are incorporated herein by reference.

### TECHNICAL FIELD

The present invention relates to an electrophoretic display medium and a method of manufacturing partition members in the electrophoretic display medium.

### BACKGROUND

One electrophoretic display medium; well known in the art is configured of a pair of substrates arranged so that one surface of each opposes the other, and a dispersion medium injected between the substrates. Charged particles carrying either a positive or a negative charge are dispersed in the dispersion medium.

In this type of electrophoretic display medium, one of the substrates is formed of a transparent material, the surface of the transparent substrate functions as a display surface. When electric fields are applied to the electrophoretic display medium, the charged particles migrate between the substrates, forming desired images on the display surface based on this migration. One such electrophoretic d-splay medium has two types of charged particles injected between the substrates, each type having a different color and polarity, and displayed images are modified by changing the type of particles collected at the substrate on the display surface side.

Another type of electrophoretic display medium employs only a single type of charged particles, so that the color of the charged particles is visible when the particles collect at the substrate on the display, surface side, while the color of the dispersion medium is visible when the charged particles collect at the substrate on the opposite side. In this way, the displayed image can be changed.

With these types of electrophoretic display media, the specific gravities of the charged particles and the dispersion medium differ greatly. As a consequence, the charged particles have a tendency to be distributed unevenly between the substrates in the electrophoretic display medium. This causes lack of uniformity of the image. To resolve this problem, partition members have been disposed between the pair of substrates, dividing the space between the substrates into a plurality of compartments along with the surface of substrates, thereby producing an electrophoretic display medium that can prevent the uneven distribution of charged particles.

Japanese unexamined patent application publication No. 2002-72258 describes a method of forming partition members between the substrates of the electrophoretic display medium using photolithography.

However, the process of forming partition members according to photolithography in the conventional method involves numerous steps, including a resist applying step, a baking step, an exposing step, and a developing step to remove unnecessary parts. Accordingly, this method is labor-intensive and time-consuming.

### SUMMARY

It is an object of the present invention to provide an electrophoretic display medium and a method of manufacturing the electrophoretic display medium conducive to mass-production.

To achieve the above and other objects, a method of manufacturing an electrophoretic display medium according to the present invention includes a clamping step, an injection step and a molding step in the clamping step, the surface of a first die with a partition-forming groove pattern formed therein is clamped against a first substrate. In the injecting step, a resin is injected into spaces formed between the first die and the first substrate. In the molding step, the resin infected into the spaces is solidified, thereby forming a partition member for partitioning a space between the first substrate and a second substrate disposed in opposition to each other.

According to another aspect of the invention, a method of manufacturing an electrophoretic display medium includes a hole-punching step, a conveying step, a clamping step, an injecting step and a molding step. In the hole-punching step, a plurality of through-holes is formed in a first substrate by clamping the first substrate between the surface of a first die, in which are formed a plurality of protrusions for forming the plurality of through-holes in the first substrate and a partition-forming groove pattern for forming a partition member on the first substrate, and the surface of a second die on which are formed a plurality of second depressions corresponding to the respective positions of the partition-forming groove pattern individually and a plurality of third depressions respectively corresponding to each of the plurality of protrusions. In the conveying step, the first substrate is conveyed to a position in which the plurality of through-holes is aligned with the partition-forming groove pattern in the first die. In the clamping step, the first substrate is clamped between the surface of the first die on which the plurality of protrusions and the partition-forming groove pattern are formed, and the surface of the second die in which the plurality of second depressions and the plurality of third depressions are formed. In the injecting step, a resin is injected into spaces formed between the first die and the second die with the first substrate clamped therebetween. In the molding step, the resin injected into the spaces is solidified.

According to further aspect of the invention, a method of manufacturing an electrophoretic display medium includes a hole forming step, a conveying step, a clamping step, an injecting step and a molding step. In the hole forming step, a plurality of through-holes is formed in a first substrate by clamping the first substrate between a first die in which are formed a plurality of third depressions and a partition-forming groove pattern for forming a partition member on the first substrate, and a second die on which are formed a plurality of protrusions aligned with the plurality of third depressions for forming the plurality of through-holes in the first substrate and a plurality of second depressions aligned with the partition-forming groove pattern. In the conveying step, the first substrate is conveyed to a position at which the plurality of through-holes is aligned with the partition-forming groove pattern formed in the first die. In the clamping step, the first substrate is clamped between the surface of the first die in which the plurality of third depressions and the partition-forming groove pattern are formed, and the surface of the second die on which the plurality of protrusions and the plurality of second depressions are formed. In the injecting step, a resin is injected into spaces formed between the first die and the second die with the first substrate clamped therebetween. In the molding step, the resin injected into the spaces is solidified.

According to another aspect of the present invention, an electrophoretic display medium includes a first substrate and a second substrate disposed in opposition to each other, a dispersion medium injected between the first substrate and second substrate with charged particles dispersed therein, and a partition member that partitions a space between the first substrate and the second substrate. A plurality of through-holes is formed in the first substrate, and the partition member includes a plurality of anchoring parts formed by a resin flowing into the plurality of through-holes for fixing the partition member to the first substrate.

According to further aspect of the present invention, an electrophoretic display medium includes a first substrate and a second substrate disposed in opposition to each other, a dispersion medium injected between the first substrate and second substrate with charged particles dispersed therein, a partition member that partitions a space between the first substrate and the second substrate. A plurality of linking parts is formed in the first substrate for fixing the partition member to the first substrate, and a plurality of anchoring parts formed by a resin flowing into the plurality of linking parts is formed in the partition member.

### BRIEF DESCRIPTION OF THE DRAWINGS

In the drawings:

FIG. 1 is a cross-sectional view of an electrophoretic display medium according to a first embodiment;

FIG. 2(a) is an explanatory diagram showing one side surface of a first substrate on which a partition member is formed;

FIG. 2(b) is an explanatory diagram showing the other side surface of the first substrate;

FIG. 2(c) is a cross-sectional view of the first substrate;

FIG. 2 (d) is a cross-sectional view of the first substrate;

FIG. 3 is a perspective view illustrating the positional relationship of a bottom die, a top die, and the first substrate when forming the partition member;

FIG. 4 is a cross-sectional view of the arrangement in FIG. 3 along the line A-A;

FIG. 5 is a plan view of the bottom die;

FIG. 6 is a plan view of the top die;

FIG. 7 is a cross-sectional view of a bottom die and a top die according to a second embodiment;

FIG. 8 is a cross-sectional view of the first substrate after forming partitions;

FIG. 9 is a cross-sectional view of the first substrate after forming anchoring parts;

FIG. 10 is a cross-sectional view of an electrophoretic display medium according to a variation of the embodiments after forming a film on the first substrate; and

FIG. 11 is a cross-sectional view of a bottom die and a top die according to a variation of the embodiments.

### DETAILED DESCRIPTION

Next, an electrophoretic display medium 10 according to a first embodiment of the present invention will be described.

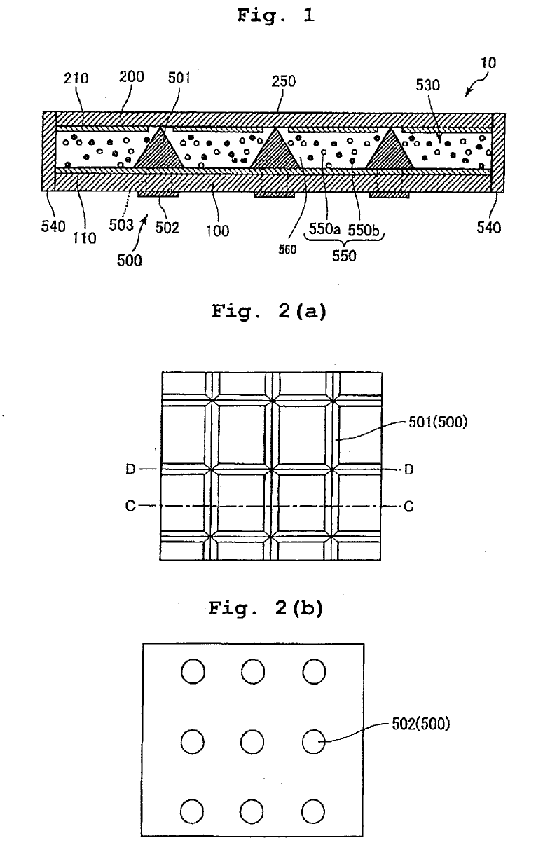

FIG. 1 is a cross-sectional view of the electrophoretic display medium 10 according to the first embodiment. As shown in FIG. 1, the electrophoretic display medium 10 includes a first substrate 100, a transparent second substrate 200, a sealing wall 540 for sealing the periphery of the first and second substrates 100 and 200, and a partition member 500. A first electrode 110 configured of a single sheet electrode is formed over an entire surface of the first substrate 100. A plurality of transparent second electrodes 210 corresponding to each pixel in the electrophoretic display medium is formed on the inner surface of the second substrate 200.

The first and second substrates 100 and 200 are arranged so that the surfaces on which electrodes are provided oppose each other. In this way, the first electrode 110 opposes all second electrodes 210. A dispersion medium 560 is injected between the first and second substrates 100 and 200. Dispersed within the dispersion medium 560 are white charged particles 550a having a positive polarity, and black charged particles 550b having a negative polarity. The white charged particles 550a and black charged particles 550b will be collectively referred to as charged particles 550.

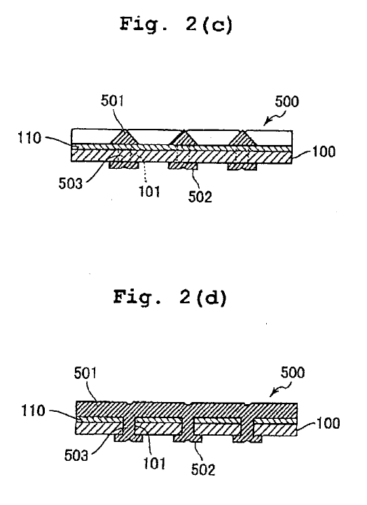

FIG. 2(a) is an explanatory diagram of the first substrate 100 in which the partition member 500 is formed from the side surface on which the first electrode 110 is formed. FIG. 2(b) is an explanatory diagram of the first substrate 100 from the side surface opposite that on which the first electrode 110 is formed. FIG. 2(c) is a cross-sectional view of the first substrate 100 along the line C-C in FIG. 2(a). FIG. 2(d) is a cross-sectional view of the first substrate 100 along the line D-D in FIG. 2(a).

As shown in FIGS. 2(c) and 2(d), a plurality of through-holes 101 is formed in the first substrate 100 through the first electrode 110. The partition member 500 is configured of a partitioning part 501 protruding from the surface of the first substrate 100 on which the first electrode 110 is formed; anchoring parts 502 visible from the opposite side surface; and linking parts 503 linking the partitioning part 501 to the anchoring parts 502.

The partitioning part 501 has a lattice shape and functions to partition the space between the first and second substrates 100 and 200. The width of the partitioning part 501 grows narrower toward the second substrate 200. Specifically, the partitioning part 501 has a triangular shape in cross section.

The linking parts 503 are formed at intersecting points of the lattice-shaped partitioning part 501 and penetrate the through-holes 101 in the first substrate 100 to link the partitioning part 501 to the anchoring parts 502.

The anchoring parts 502 have a circular shape with a larger diameter than the through-holes 101 in order to prevent the partitioning part 501 linked to the anchoring parts 502 by the linking parts 503 from coining off the surface of the first substrate 100. In this way, the partition member 500 is fixed to the first substrate 100.

Next, the process of switching the displayed image on the electrophoretic display medium 10 having the above structure will be described. Since both the second substrate 200 and the second electrodes 210 are transparent, images can be viewed on the second substrate 200 side. The surface of the second substrate 200 opposite the surface on which the second electrodes 210 are provided is referred to as a display surface 250.

When a voltage of 40 V is applied to the first electrode 110 and a voltage or 0 V to the second electrodes 210, for example, the positively charged white particles 550a migrate toward the second electrode 210 side. Consequently, the color white is visible through the display surface 250.

On the other hand, when a voltage of 40 V is applied to the first electrode 110 and a voltage of 80 V to the second electrodes 210, the negatively charged black particles 550b migrate to the second electrode 210 side. Consequently, the color black is visible through the display surface 250.

With the electrophoretic display medium 10 having the above construction, the linking parts 503 are formed at intersecting points of the lattice-shaped partition member 500, and the partitioning part 501 partitions the space between the first and second substrates 100 and 200 into compartments 530, thereby reliably preventing an uneven distribution of the charged particles 550.

Further, the partition member 500 is formed on the first substrate 100 side in the electrophoretic display medium 10 of the preferred embodiment. Accordingly, the partitioning part 501 is less noticeable when viewing the electrophoretic display medium 10 from the display surface 250 side, giving the display surface 250 a high level of visibility.

Further, since the partitioning part 501 grows narrower in width toward the second substrate 200 side, the partitioning part 501 is even less noticeable when viewing the electrophoretic display medium 10 from the display surface 250 side, giving the display surface 250 a high level of visibility.

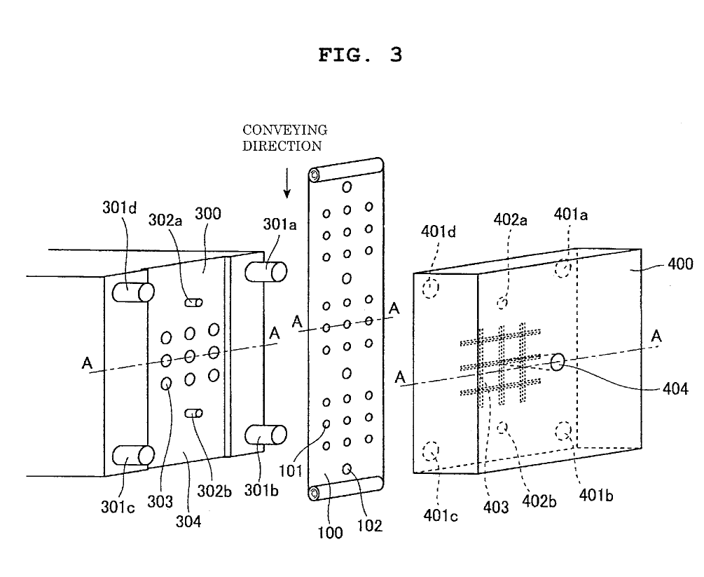

Next, the method of manufacturing the partition member 500 will be described. In the preferred embodiment, the partition member 500 is formed through a conveying step for conveying the first substrate 100 having the first electrode 110 formed thereon between a top die 400 and a bottom die 300 (see FIG. 3); a clamping step for tightly clamping the first substrate 100 between the bottom die 300 and top die 400; an injecting step for injecting liquid polycarbonate melted with heat into spaces formed by the top die 400, bottom die 300, and first substrate 100; and a molding step for cooling and solidifying the polycarbonate filling the spaces described above.

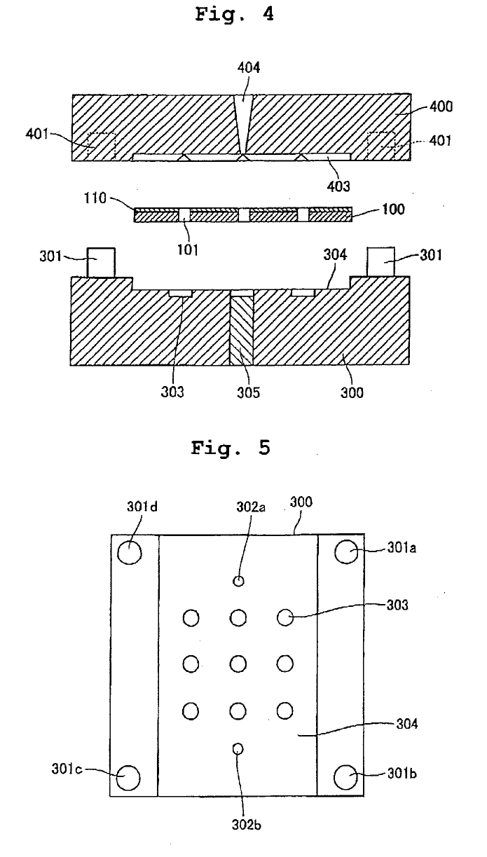

Here, the positional relationships of the bottom die 300, top die 400, and first substrate 100 will be described with reference to FIGS. 3 and 4 FIG. 3 is a perspective view showing the positional relationships of the bottom die 300, top die 400, and first substrate 100 for forming the partition member 500. FIG. 4 is a cross-sectional view of the arrangement in FIG. 3 along the line A-A.

As shown in FIG. 3, the bottom die 300 and top die 400 are disposed in positions confronting one another, and the first substrate 100 rolled on both ends like a scroll is sequentially conveyed between the bottom die 300 and top die 400. As indicated by the arrow in FIG. 3, the first substrate 100 is conveyed downward with respect to the drawing. The first substrate 100 is formed of polycarbonate and has the single sheet of first electrode 110 formed over the entire surface of the first substrate 100 facing the top die 400.

As shown in FIGS. 3 and 4, the plurality of through-holes 101 and a plurality of positioning holes 102 are formed in the first substrate 100. The through-holes 101 are formed at positions for aligning with depressions 303 formed in the bottom die 300 described later when the first substrate 100 is conveyed into position between the bottom die 300 and top die 400. The positioning holes 102 are formed in positions for aligning with positioning pins 302a and 302b described later when the first substrate 100 is conveyed into position between the bottom die 300 and top die 400. When opening and closing the bottom die 300 and top die 400 over the first substrate 100, the bottom die 300 serves as the moving side, while the top die 400 is stationary.

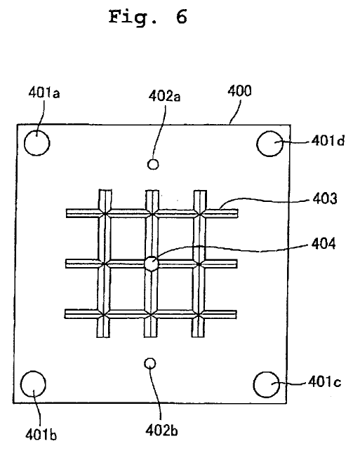

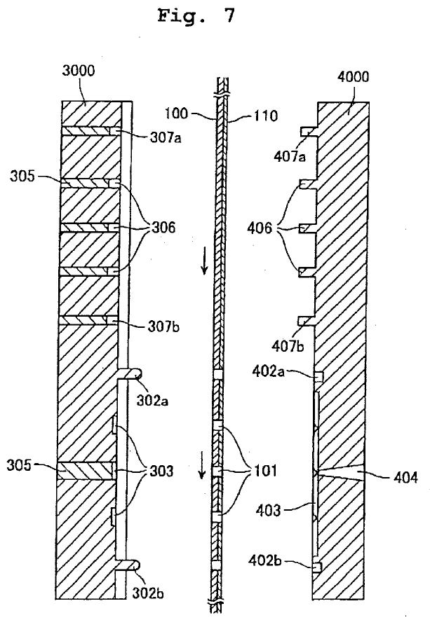

Next, the bottom die 300 and the top die 400 used in the method of manufacturing the partition member 500 according to the preferred embodiment will be described with reference to FIGS. 5 and 6.

FIG. 5 is a plan view of the bottom die 300. As shown in FIG. 5, the bottom die 300 has a rectangular shape in plan view. Guide pins 301a-301d (collectively referred to as guide pins 301) are formed in the four corners of the bottom die 300 at positions for engaging with guide bushes 401a-401d (collectively referred to as guide bushes 401) of the top die 400 described latex.

A substrate-mounting surface 304 is formed in the center region of the bottom die 300 so as to be recessed into the bottom die 300 relative to the surface on which the guide pins 301a-301d are provided by a distance equivalent to the thickness of the first substrate 100. The substrate-mounting surface 304 has a width identical to the width of the first substrate 100. The positioning pins 302a and 302b for engaging in the positioning holes 102 of the first substrate 100 are formed on the substrate-mounting surface 304 at positions separated from the legion in which the partition member 500 is to be formed when the first substrate 100 is positioned on the substrate-mounting surface 304.

A plurality of columnar depressions 303 is formed in the substrate-mounting surface 304 at positions opposing the plurality of through-holes 101 formed in the first substrate 100 when the first substrate 100 is positioned on the substrate-mounting surface 304. The diameter of the depressions 303 positioned on the bottom surface of the first substrate 100 is greater than the diameter of the through-holes 101. As shown in FIG. 4, an ejecting pin 305 is formed in the center region of the bottom die 300 for removing the first substrate 100 from the bottom die 300 in the process described later.

FIG. 6 is a plan view of the top die 400. As shown in FIG. 6, recessed guide bushes 401a-401d are formed in the top die 400 at positions opposing the guide pins 301a-301d of the bottom die 300. When the first substrate 100 is clamped between the top die 400 and bottom die 300, the guide pins 301a-301d are inserted into the corresponding guide bushes 401a-401d. In this way, the top die 400 and bottom die 300 are always engaged with each other at a prescribed position.

Recessed positioning bushes 402a and 402b are also formed in the top die 400 at positions corresponding to the positioning pins 302a and 302h of the bottom die 300. In the clamping step described later, the positioning pins 302a and 302b of the bottom die 300 are inserted into the respective recessed positioning bushes 402a and 402b of the top die 400.

A lattice-shaped partition-forming groove pattern 403 is also formed in the center region of the top die 400. An injection hole 404 is formed in the center of the partition-forming groove pattern 403 for injecting a resin, as will be described later. The injection hole 404 has a conical shape and penetrates the top die 400, with a diameter that grows narrower toward the partition-forming groove pattern 403 side of the top die 400, as shown in FIG. 4.

The width of each groove in the partition-forming groove pattern 403 grows narrower away from the surface of the top die 400 on the partition-forming groove pattern 403 side. Specifically, each groove in the partition-forming groove pattern 403 has a triangular shape in a cross section. By shaping the partition-forming groove pattern 403 in this way, the top die 400 can be peeled away from the partition member 500 with less resistance after the partition member 500 is formed.

Since the width of the substrate-mounting surface 304 formed in the bottom die 300 is the same as the width of the first substrate 100, as described above, the first substrate 100 is first positioned on the substrate-mounting surface 304 after being conveyed into position in the conveying direction and before bringing the bottom die 300 and top die 400 together. In this way, the first substrate 100 can be reliably positioned relative to the bottom die 300 and top die 400 through the engagement of the positioning pins 302a and 302b and the recessed positioning bushes 402a and 402b and through the engagement of the guide pins 301a-301d and the guide bushes 401a-401d.

After positioning the first substrate 100, the through-holes 101 are aligned with intersecting points of the lattice-shaped partition-forming groove pattern 403 formed in the top die 400 and the depressions 303 formed in the bottom die 300.

Next, each step in the method of manufacturing the partition member 500 will be described. First, the conveying step is performed to convey the first substrate 100 between the bottom die 300 and top die 400. At this time, the first substrate 100 is conveyed with the surface of the first substrate 100 on which the first electrode 110 is formed facing the top die 400.

Next, the clamping step is performed to closely clamp the first substrate 100 conveyed to the correct position in the conveying step between the top die 400 and bottom die 300. At this time, the positioning pins 302a and 302b of the bottom die 300 are inserted through the positioning holes 102 of the first substrate 100 and inserted into the recessed positioning bushes 402a and 402b of the top die 400, and the guide pins 301 of the bottom die 300 are inserted into the guide bushes 401 of the top die 400, thereby positioning the first substrate 100 between the bottom die 300 and top die 400.

Next, the injecting step is performed to introduce a molten polycarbonate through the injection hole 404 of the top die 400.

In the ensuing molding step, the polycarbonate introduced in the injecting step is allowed to cool for a period of time from several seconds to several tens of seconds so as to solidify in the molds.

Subsequently, the bottom die 300 and top die 400 are opened. In some cases, the first substrate 100 may stick to the bottom die 300 due to the pressure applied when the first substrate 100 was clamped between the bottom die 300 and top die 400. However, the first substrate 100 can be separated from the bottom die 300 by pushing the ejecting pin 305 in the bottom die 300. In this way, formation of the partition member 500 on the first substrate 100 is complete.

In the method of manufacturing the partition member 500 according to the preferred embodiment described above, the same polycarbonate material as that constituting the first substrate 100 is introduced in the injecting step because similar materials have a high adhesion, enabling the partition member 500 to adhere reliably to the first substrate 100. More particularly, since polycarbonate is a noncrystalline resin and has greater adhesion than a crystalline resin, the partition member 500 can reliably adhere to the first substrate 100.

A complex shape, such as that of the anchoring parts 502 and linking parts 503 that are integrally formed on both side surfaces of the first substrate 100, is not easy to manufacture using a conventional method such as photolithography. However, the method of forming the partition member 500 on the first substrate 100 according to injection molding in the preferred embodiment is not time-consuming and labor-intensive like the conventional method of forming the partition members through photolithography and, therefore, is suitable for mass-production.

When using injection molding in the manufacturing method, the polycarbonate material contracts slightly when cooling in the molding step. Since portions of the polycarbonate at which the linking parts 503 are formed have a greater volume than portions at which linking parts 503 are not formed, the top portion of the partitioning part 501 tends to be drawn downward at portions corresponding to the linking parts 503 farther than the surface area around these portions, even when the polycarbonate contracts at a uniform rate.

However, since the linking parts 503 are formed at intersecting positions in the lattice-shaped partitioning part 501 in the method of manufacturing the partition member 500 according to the preferred embodiment, gaps through which the charged particles 550 can migrate are not formed in unintended areas between the second substrate 200 and partition member 500, thereby reliably preventing an uneven distribution of the charged particles 550.

Next, a method of manufacturing partition members in an electrophoretic display medium according to a second embodiment of the present invention will be described.

In the second embodiment, rather than initially forming the through-holes 101 in the first substrate 100, the through-holes 101 are punched in the first substrate 100 at the same time the partition member 500 is formed using the same molds for forming the partition member 500.

Accordingly, a bottom die 3000 and a top die 4000 according to the second embodiment are provided with mechanisms fox punching the through-holes 101 and positioning holes 102 in the first substrate 100. These mechanisms are provided upstream in the conveying direction from the structure for forming the partition member 500 using the same injection molding process performed in the first embodiment with the bottom die 300 and top die 400. FIG. 7 is a cross-sectional view of the bottom die 3000 and top die 4000 used in the second embodiment, wherein like parts and components are designated with the same reference numerals to avoid duplicating description.

As shown in FIG. 7, a plurality of protrusions 406 for punching the through-holes 101 in the first substrate 100, and protrusions 407a and 407b for punching the positioning holes 102 in the first substrate 100 are provided in the upstream section of the top die 4000 in the conveying direction. Further, depressions 306 are formed in the bottom die 3000 at positions corresponding to the protrusions 406, a depression 307a is formed in the bottom die 3000 at a position corresponding to the protrusion 407a, and a depression 307b is formed in the bottom die 3000 at a position corresponding to the protrusion 407b.

When the first substrate 100 is clamped between the bottom die 3000 and top die 4000, the protrusions 406 and depressions 306 form the through-holes 101 in the first substrate 100, while the protrusion 407a and depression 307a and the protrusion 407b and depression 307b form the positioning holes 102 in the first substrate 100.

At the same time, the partition member 500 is formed according to the same method described in the first embodiment in the downstream section in the conveying direction. In other words, in the second embodiment, the partition member 500 is formed on the downstream side in the conveying direction, while the through-holes 101 and positioning holes 102 are formed on the upstream side in the conveying direction in preparation for forming the next partition member 500.

Since the method according to the second embodiment can form the through-holes 101 and positioning holes 102 in the first substrate 100 and the partition member 500 in the first substrate 100 using the same dies, the partition member 500 can be formed more effectively on the first substrate 100 than in the first embodiment.

While the shape of the partition member 500 formed by the partition-forming groove pattern 403 has been abbreviated in FIG. 7, it should be apparent that the partition member 500 is actually formed with a larger partitioned area. Further, the anchoring parts 502 and linking parts 503 need not be formed at each intersecting point of the lattice structure, but may be formed in intersecting point at suitable intervals.

Further, while the anchoring parts 502 and linking parts 503 are formed at intersecting points of the lattice in the preferred embodiments, the anchoring parts 502 and linking parts 503 may be formed at positions other than the intersecting points when using a material that contracts little when cooling and solidifying.

Further, while the partition-forming groove pattern 403 is formed in a lattice shape in the preferred embodiments, the partition-forming groove pattern 403 may be formed in a mesh-like shape (a shape configured of triangular or polygonal partitioning parts or partitioning parts having a completely random shape), but is not particularly limited to a mesh-like shape.

Further, while the through-holes 101 are formed in the first substrate 100 and the depressions 303 are formed in the bottom die 300 in the preferred embodiments described above in order to form the anchoring parts 502 and linking parts 503, it is not necessary to form the through-holes 101 in the first substrate 100 and the depressions 303 in the bottom die 300, provided that the partition member 500 can be reliably and physically anchored without the anchoring parts 502 and linking parts 503.

Further, the partition member 500 may be formed on a first substrate 100 without the first electrode 110 formed thereon. In this case, a separate electrode may be provided on the outside of the electrophoretic display medium, and a voltage may be applied to this electrode to generate an electric field for effecting electrophoresis of the charged particles 550.

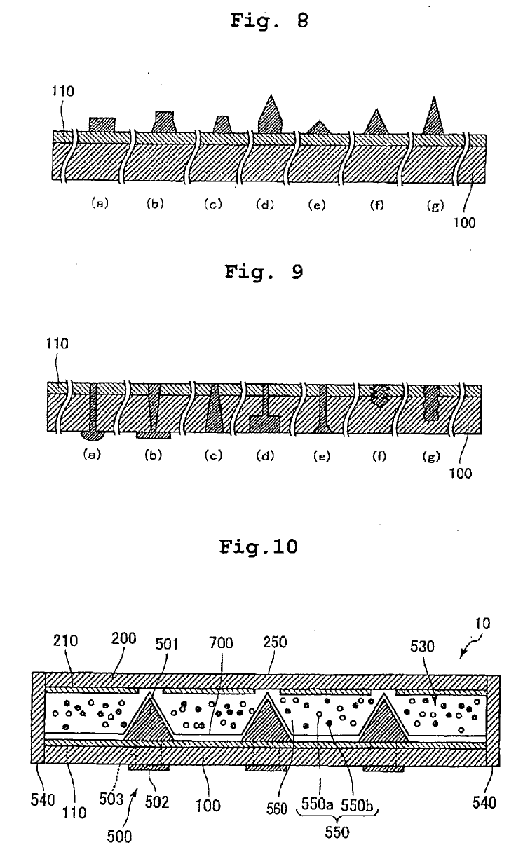

Further, while the partition member 500 formed in the preferred embodiments has a partitioning part 501 with a triangular cross section, the partition member 500 is not particularly limited to this shape. FIG. 8 is an explanatory diagram conceptually illustrating other examples of the partitioning part 501. For example, the partitioning part 501 may be shaped with a rectangular cross section, as shown in FIG. 3(a); a cross section having a rectangular top portion and a trapezoidal bottom portion, as shown in FIG. 8(b); a trapezoidal cross section, as shown in FIG. 8(c); a cross section having a tapered top and a rectangular bottom, as shown in FIG. 8(d); or various triangular cross sections having different heights, as illustrated in FIGS. 8(e) through 8(g). Since the partition member 500 is formed on the first substrate 100 according to injection molding in the present invention, partition members of a variety of shapes can be formed simply by forming dies in the appropriate shape.

Further, the anchoring parts 502 and linking parts 503 axe not limited to the shapes described in the preferred embodiments FIGS. 9(a) and 9(b) are cross-sectional views showing other shapes of the anchoring part 502 and linking part 503. In FIG. 9(a), the anchoring part 502 has a semispherical shape. In FIG. 9(b), the linking part 503 grows narrower toward the anchoring part 502. In fact, the anchoring parts 502 and linking parts 503 may have any shape for anchoring the partition member 500 reliably to the first substrate 100, provided that the anchoring part 502 protrudes on the underside of the substrate and is shaped to catch on the underside surface and the linking part 503 links the anchoring part 502 to the partitioning part 501 (not shown).

The anchoring parts 502 need not even be provided if suitable holes or recessed parts are formed in the first substrate 100. In this case, the linking parts 503 function as the anchoring parts 502 for reliably anchoring the partition member 500 to the first substrate 100. While the holes or recessed parts may have a simple columnar shape, FIGS. 9(c) through 9(g) show examples of other shapes. As shown in FIG. 9(c), holes may be formed in the first substrate 100 with a diameter that grows narrower toward the partitioning parts (not shown). As shown in FIG. 9(d), the partition member 500 is reliably anchored to the first substrate 100 by forming holes in the first substrate 100 such that the bottom portion is larger than the top portion. As shown in FIG. 9(e), the hole may be formed to gradually slope outward on the bottom side.

In place of the through-holes 101, recessed parts such as those shown in FIGS. 9(f) and 9(g) may be provided in the first substrate 100 for anchoring the partition member 500 to the first substrate 100. In the example of FIG. 9(f), the recessed part has protrusions extending laterally for reliably anchoring the partition member 500. In these examples, the bottom die 3000 in the second embodiment is not necessarily required.

In the preferred embodiments described above, two colors of charged particles 550, i.e., the white charged particles 550a and black charged particles 550b, are injected into the compartments 530, but the present invention is not limited to these embodiments. For example, the present invention may be applied to a method of manufacturing partition members in an electrophoretic display medium that switches the display between the color of the charged particles and the color of a colored dispersion medium or a full-color electrophoretic display medium well known in the arts.

Further, after forming the partition member 500 on the first substrate 100 as described in the preferred embodiments, it is also possible to form a film 700 over the surface of the first substrate 100 on which the partitioning part 501 protrudes to prevent the dispersion medium 560 from leaking out between the first substrate 100 and partition member 500, as shown in FIG. 10.

Further, while the partition member 500 is formed in the preferred embodiments by introducing polycarbonate in the injecting step, it is possible to use another resin material, such as acrylic (PMMA), polystyrene, polyarylate, polymethylpentene, polyester, and polyamide.

Further, instead of injecting polycarbonate in the injecting step, the partition member 500 may be formed using another thermoplastic resin, provided that the resin material is suited to injection molding. Examples of this resin material include acrylic (PMMA), polystyrene, polyarylate, polymethylpentene, polyester, and polyamide.

Further, instead of injecting polycarbonate in the injecting step, another transparent resin may be used, such as acrylic (PMMA), polystyrene, polvarylate, polymethylpentene, polyester, and polyamide.

Further, instead of injecting polycarbonate in the injecting step, the partition member 500 may be formed of another noncrystalline resin capable of bonding to the first substrate 100, such as acrylic (PMMA), polystyrene, and polyarylate.

In the first embodiment described above, the bottom die 300 functions as the moving side and the top die 400 as the stationary side, but the top die 400 may be used as the moving side and the bottom die 300 as the stationary side.

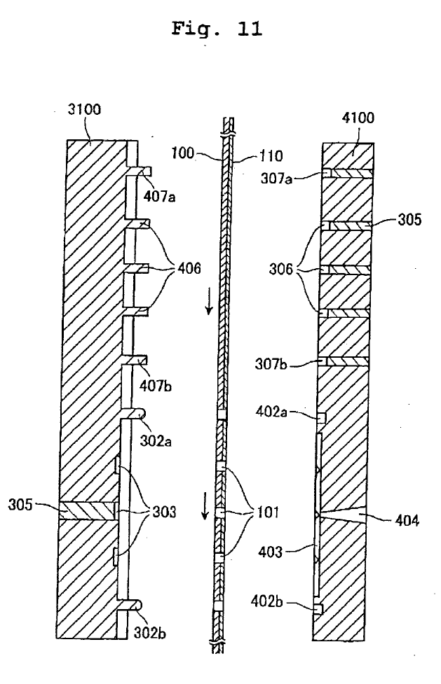

Further, the bottom die 3000 and top die 4000 axe not limited to the structure shown in FIG. 7. For example, the manufacturing method may use a bottom die 3100 having protrusions 406 and a top die 4100 having depressions 306, as illustrated in FIG. 11.

What is claimed is:

1. A method of manufacturing an electrophoretic display medium, comprising:
a clamping step for clamping a surface of a first die having a partition-forming groove pattern against a first substrate;
an injecting step for injecting a resin into spaces formed between the first die and the first substrate; and
a molding step for solidifying the resin injected into the spaces, thereby forming a partition member for partitioning a space between the first substrate and a second substrate disposed in opposition to each other.

2. The method according to claim 1, wherein the partition-forming groove pattern of the first die is formed in a mesh shape.

3. The method according to claim 1, wherein a plurality of first depressions is formed in the first substrate at positions corresponding to the partition-forming groove pattern; and
the first die is clamped against the first substrate so that the plurality of first depressions is aligned with respective positions of the partition-forming groove pattern individually.

4. The method according to claim 3, wherein the plurality of first depressions formed in the first substrate respectively corresponds to intersecting points in the mesh shape of the partition-forming groove pattern; and
the first die is placed against the first substrate so that the plurality of first depressions is aligned with respective intersecting points of the mesh-shaped partition-forming groove pattern individually.

5. The method according to claim 1, wherein a plurality of through-holes is formed in the first substrate at positions corresponding to the partition-forming groove pattern;
the first substrate is clamped between the first die and a second die so that the plurality of through-holes is aligned with respective positions of partition-forming groove pattern individually; and
the resin is injected into spaces formed between the first die and the second die with the first substrate clamped therebetween.

6. The method according to claim 5, wherein the plurality of through-holes formed in the first substrate respectively corresponds to intersecting points in the mesh-shaped partition-forming groove pattern; and
the first substrate is clamped between the first die and the second die so that the plurality of through-holes is aligned with respective intersecting points of the mesh-shaped partition-forming groove pattern individually.

7. The method according to claim 5, wherein a plurality of second depressions is formed in the second die at positions corresponding to the plurality of through-holes respectively; and
the first substrate is clamped between the first die and the second die so that each of the plurality of through-holes is respectively aligned with each of the plurality of second depressions.

8. The method according to claim 1, further comprising a film-forming step wherein a film is formed over the surfaces of the first substrate and the partition member after the molding step.

9. The method according to claim 1, wherein a transparent resin is injected into the spaces.

10. The method according to claim 1, wherein a thermoplastic resin is injected into the spaces.

11. The method according to claim 1, wherein a noncrystalline resin is injected into the spaces.

12. The method according to claim 1, wherein a polycarbonate resin is injected into the spaces.

13. The method according to claim 1, wherein an acrylic resin is injected into the spaces.

14. The method according to claim 1, wherein the first substrate is formed of a noncrystalline resin.

15. The method according to claim 1, wherein an electrode is formed over one surface of the first substrate; and
the first die is clamped against the surface of the first substrate on which the electrode is formed.

16. The method according to claim 1, wherein the partition-forming groove pattern is formed in the first die with sloped side surfaces; and
the surface of the first die in which the partition-forming groove pattern is formed is clamped against the first substrate.

17. A method of manufacturing an electrophoretic display medium comprising:
a hole-punching step wherein a plurality of through-holes is formed in a first substrate by clamping the first substrate between a surface of a first die, in which axe formed a plurality of protrusions that forms the plurality of through-holes in the first substrate and a partition-forming groove pattern that forms a partition member on the first substrate, and a surface of a second die on which are formed a plurality of second depressions corresponding to the respective positions of the partition-forming groove pattern individually and a plurality of third depressions respectively corresponding to each of the plurality of protrusions;
a conveying step wherein the first substrate is conveyed to a position in which the plurality of through-holes is aligned with the partition-forming groove pattern in the first die;
a clamping step wherein the first substrate is clamped between the surface of the first die on which the plurality of protrusions and the partition-forming groove pattern are formed, and the surface of the second die in which the plurality of second depressions and the plurality of third depressions are formed;
an injecting step wherein a resin is injected into spaces formed between the first die and the second die with the first substrate clamed therebetween; and
a molding step wherein the resin injected into the spaces is solidified.

18. The method according to claim 17, wherein the partition-forming groove pattern has a mesh shape; and
the first substrate is clamped between the first die having the mesh-shaped partition-forming groove pattern and the second die.

19. The method according to claim 18, wherein the plurality of through-holes is formed at positions respectively corresponding to intersecting points of the mesh-shaped partition-forming groove pattern.

20. A method of manufacturing an electrophoretic display medium comprising:
a hole forming step wherein a plurality of through-holes is formed in a first substrate by clamping the first substrate between a first die in which axe formed a plurality of third depressions and a partition-forming groove pattern that forms a partition member on the first substrate, and a second die on which are formed a plurality of protrusions aligned with the plurality of third depressions that forms the plurality of through-holes in the first substrate and a plurality of second depressions aligned with the partition-forming groove pattern;
a conveying step wherein the first substrate is conveyed to a position at which the plurality of through-holes is aligned with the partition-forming groove pattern formed in the first die;
a clamping step wherein the first substrate is clamped between the surface of the first die in which the plurality of third depressions and the partition-forming groove pattern are formed, and the surface of the second die on which the plurality of protrusions and the plurality of second depressions are formed;
an injecting step wherein the resin is injected into spaces formed between the first die and the second die with the first substrate clamped therebetween; and
a molding step wherein the resin infected into the spaces is solidified.

21. An electrophoretic display medium comprising:
a first substrate and a second substrate disposed in opposition to each other;
a dispersion medium injected between the first substrate and second substrate and having charged particles dispersed therein; and
a partition member that partitions a space between the first substrate and the second substrate;
wherein a plurality of through-holes is formed in the first substrate, and the partition member comprises a plurality of anchoring parts formed by a resin flowing into the plurality of through-holes that fixes the partition member to the first substrate.

22. The electrophoretic display medium according to claim 21, wherein the partition member has a mesh shape; and
the plurality of anchoring parts is formed at positions respectively corresponding to intersecting points of the mesh shape.

23. The electrophoretic display medium according to claim 21, wherein a film is formed on the surfaces of the first substrate and the partition member.

24. The electrophoretic display medium according to claim 21, wherein the second substrate is transparent.

25. The electrophoretic display medium according to claim 21, wherein the partition member has a tapered shape.

26. An electrophoretic display medium comprising:
a first substrate and a second substrate disposed in opposition to each other;
a plurality of linking parts formed in the first substrate, the linking parts fixing the partition member to the first substrate; and
a dispersion medium injected between the first substrate and second substrate and having charged particles dispersed therein; and
a partition member that partitions a space between the first substrate and the second substrate, the partition member comprising a plurality of anchoring parts formed by a resin flowing into the plurality of linking parts.
